(19) United States
(12) Patent Application Publication
(10) Pub. No.: US 2008/0199821 A1
(43) Pub. Date: Aug. 21, 2008

(54) Method And Apparatus For Cooling A Material To Be Removed From The Grate Of A Fluidized Bed Furnace

(75) Inventors: Jens Nyberg, Kokkola (FI); Vesa Kartsalo, Kokkola (FI); Heikki Siirila, Kokkola (FI); Heikki Peralahti, Kokkola (FI)

Correspondence Address: MERCHANT & GOULD PC, P.O. BOX 2903, MINNEAPOLIS, MN, 55402-0903, US

(73) Assignee: Outokumpu Technology OY, Espoo (FI)

(21) Appl. No.: 10/566,045

(22) PCT Filed: Jul. 14, 2004
(86) PCT No.: PCT/FI2004/000454

§ 371 Date: Mar. 25, 2008

(30) Foreign Application Priority Data
Jul. 29, 2003 (FI) 20031113

(51) Int. Cl. F27D 15/02

(52) U.S. Cl. 432/77; 165/104.18

(57) ABSTRACT

The invention relates to a method and an apparatus for cooling a material to be removed from the grate of a fluidized bed furnace. Material at a high temperature is passed from the grate of the fluidized bed furnace into a fluidized bed cooler in charges of a given size by measuring the quantity of the material accumulating in the fluidized bed cooler. When the quantity of the material in the cooler has reached a predetermined limit value, the supply of material into the fluidized bed cooler is prevented. The charge is cooled in the fluidized bed cooler by fluidization air and via heat transfer into a cooling liquid circulation system and the temperature of the charge is measured. The charge is removed when the temperature of the charge has fallen to a predetermined limit value. The second end (5) of a supply conduit (3) is provided with a supply valve (15) actuated by a power means (16). A discharge conduit (14) is provided with a discharge valve (17) actuated by a second power means (18). Quantity detection means (19, 20) are provided to produce quantity data regarding the amount of material in a fluidized bed space (11), and temperature measuring means (21) are provided to produce temperature data. A control device (22) controls the first power means (16) to open and close the supply valve (15) and the second power means (18) to open and close the discharge valve (17) on the basis of the quantity data and temperature data and the predetermined limit values of quantity and temperature so that the loading of material into the fluidized bed space and its cooling and removal from the fluidized bed space take place in a charge-by-charge and cyclic manner.

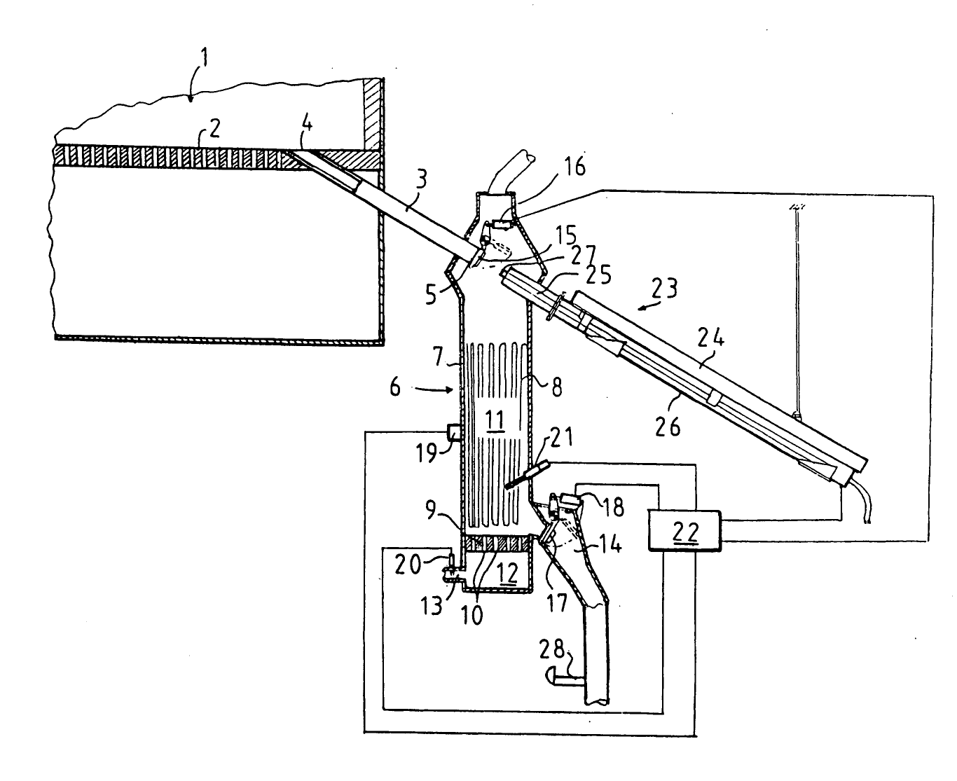

### FIELD OF THE INVENTION

The present invention relates to a method as defined in the preamble of claim 1. Moreover, the invention relates to an apparatus as defined in the pre-amble of claim 14.

### BACKGROUND OF THE INVENTION

In prior art, specification U.S. Pat. No. 4,227,488 discloses an apparatus for cooling coarse material removed from the grate of a fluidized bed furnace. The apparatus comprises a supply conduit having an upper first end, which opens to the grate of the fluidized bed furnace to receive material to be cooled from the grate into the supply conduit. Further, the apparatus comprises a fluidized bed cooler. The fluidized bed cooler has a housing, into the upper part of which the lower second end of the supply conduit opens. The housing encloses an interior space for receiving the material. Connected to the housing are cooling liquid pipes for cooling the material in the interior space. The apparatus further comprises a second grate having a number of through holes. This second grate has been arranged to divide the space inside the housing of the fluidized bed cooler into a fluidized bed space above the second grate, where the material to be cooled is present as a fluidized bed, and an air distribution space below the second grate. An air inlet duct opens into the air distribution space to supply air into the air distribution space, from where the air is passed further through the openings of the second grate into the fluidized bed space to fluidize and cool the material to be cooled. An outlet conduit opens into the fluidized bed space to remove the cooled material from the fluidized bed space.

The cooling of the material removed from the grate of the fluidized bed furnace is implemented in such manner that material at a high temperature is passed from the grate of the fluidized bed furnace into the fluidized bed cooler, where the material is cooled partly by fluidization air and partly by heat transfer into a cooling liquid circulation system. The cooled material is removed from the fluidized bed cooler, to be passed further to other process equipment. The purpose of the cooling is to reduce the temperature of the material to a lower level such that the material will not cause damage to the equipment used in further processing. The material is allowed to pass in a continuous flow from the fluidized bed furnace through the fluidized bed cooler and further to other process equipment.

A problem with the prior-art apparatus and method is that the mass flow of the material to be removed from the fluidized bed furnace and cooled can not be controllably and accurately regulated.

A further problem is that, in cooling occurring in a continuous flow, the material temperature after the cooling may vary within wide limits and the temperature can not be accurately adjusted as desired.

Further, specification EP 0 628 767 A2 discloses a fluidized bed boiler designed for refuse incineration and a method for its operation. Refuse incineration produces ash, which consists of debris introduced along with the feed material, clods accumulated in the sand bed due to impurities, and the actual ash produced by combustion. Coarse material is removed from the inclined grate of the fluidized bed boiler into a separate cooler, where the material is cooled charge by charge. The amounts of material removed during the diurnal cycle are relatively small. The material flows from the furnace into the cooler along the inclined grate, which extends from the furnace into the cooler. The movement of the material into the cooler is controlled by means of horizontal air jets from directional nozzles provided in the grate. The material is removed from the cooler by opening a discharge valve in an outlet conduit after the material has been cooled to a desired temperature.

A problem with this prior-art apparatus and method is that the mass flow of the material to be removed from the fluidized bed furnace and cooled and the quantity of the charge can not be accurately measured.

### OBJECT OF THE INVENTION

The object of the present invention is to overcome the above-mentioned drawbacks.

A specific object of the invention is to disclose a method and an apparatus whereby the mass flow of the material to be removed from a fluidized bed furnace and cooled and the final temperature after cooling can be controllably adjusted.

A specific object of the invention is to disclose a method and an apparatus that are particularly advantageous for use in conjunction with a metallurgic calcining kiln, especially a zinc furnace.

### BRIEF DESCRIPTION OF THE INVENTION

The method of the invention is characterized by what is disclosed in claim 1. Furthermore, the apparatus of the invention is characterized by what is disclosed in claim 14.

In the method of the invention

a) a material charge containing material to be cooled is loaded into a fluidized bed cooler,

b) during cooling, the temperature of the charge is measured,

c) the cooled charge is removed from the fluidized bed cooler when the temperature of the charge as indicated by the temperature measurement has fallen to a predetermined limit value of temperature, and

d) steps a)-c) are repeated cyclically. According to the invention, during the loading step a), the quantity of the material accumulating in the fluidized bed cooler is measured, and the supply of material into the fluidized bed cooler is prevented when the quantity of the material in the fluidized bed cooler corresponds to a predetermined quantity of a charge to be loaded at one time.

The apparatus of the invention comprises a supply valve disposed at the second end of the supply conduit, which supply valve in an open position allows and in a closed position prevents the supply of material into the fluidized bed space of the fluidized bed cooler. To open and close the supply valve, a first power means is provided. Further, the apparatus comprises a discharge valve disposed in a discharge conduit, which discharge valve in an open position allows and in a closed position prevents the passage of material out of the fluidized bed space. To open and close the discharge valve, a second power means is provided. The apparatus further comprises quantity detection means for producing quantity data regarding the quantity of material in the fluidized bed space, and temperature measuring means for producing temperature data regarding the temperature of the material in the fluidized bed space. Moreover, the apparatus comprises a control device, which has been arranged to control the first power means to open and close the supply valve and the second power means to open and close the discharge valve on the basis of the quantity data and temperature data and predetermined limit values of quantity and temperature, so that the loading of material into the fluidized bed space of the fluidized bed cooler and its cooling and removal from the fluidized bed space take place in a charge-by-charge and cyclic manner.

The method and apparatus of the invention prevent excessive flow of material out of the fluidized bed furnace, but they make it possible to get the coarse fraction out in a charge-by-charge manner so that the quantity of the charge is accurately controlled. Due to the accurately controlled output flow from the fluidized bed furnace and the cooling controlled on the basis of its temperature, the mass flow and quantity of the material to be passed out of the fluidized bed furnace and cooled as well as the final temperature after cooling can be controllably adjusted. Therefore, the counter-pressure of the bed in the fluidized bed furnace and the composition of the bed can be controllably regulated by making desired adjustments of the quantity of material contained in the material charge to be cooled. The apparatus can be easily automated. The method and apparatus allow the operator to know how much material is removed from the furnace, because the charge size is controlled and the number of charges (charges per hour) can be adjusted. This makes it easy to increase or decrease the amount of material to be removed from the furnace by changing the times, in other words, if its preferable in respect of furnace operation to remove more material by underflow, then the operation is accelerated, or if it is desirable to reduce the amount of material removed by underflow, then the operation is slowed down. The system enables controlled removal by underflow of a quantity of material that is suitable in respect of furnace operation. The quantity of material removed is known and the quantity can be adjusted. This is part of the control of the furnace. In addition, the temperature is under control and the composition of the material removed can be monitored by a sampling system. The essential point is that the invention enables an adjustable system to be achieved.

In an embodiment of the method, during the loading step a), the surface level of the material accumulating in the fluidized bed cooler is measured, and when the measured surface level has reached a predetermined limit value, which corresponds to a predetermined quantity of a charge to be loaded at one time, the supply of material into the fluidized bed cooler is prevented.

In an embodiment of the method, during the loading step a), the fluidization air counter-pressure caused by the material is measured, and when the measured counter-pressure has reached a predetermined limit value, which corresponds to a predetermined quantity of a charge to be loaded at one time, the supply of material into the fluidized bed cooler is prevented.

In an embodiment of the method, a supply conduit extending between the grate of the fluidized bed furnace and the fluidized bed cooler is provided, and during the loading step a) the material is allowed to flow out from the grate via the supply conduit into the fluidized bed cooler by gravitation.

In an embodiment of the method, the fluidized bed cooler is provided with a discharge conduit for the discharge of material from the fluidized bed cooler, and during the discharge step c) the material is allowed to flow out of the fluidized bed cooler via the discharge conduit by gravitation.

In an embodiment of the method, the supply conduit is cleaned periodically at regular or irregular time intervals.

In an embodiment of the method, the filling time required for filling the fluidized bed cooler with a material charge is determined, the measured filling time is compared to a predetermined filling time limit value, and if the measured filling time exceeds the predetermined limit value, then the supply conduit is cleaned.

In an embodiment of the method, the supply conduit is cleaned by blowing pressurized air through the supply conduit.

In an embodiment of the method, the exhaustion of the fluidized bed cooler is established on the basis of a determination of surface level and/or counter-pressure after the surface level and/or counter-pressure have/has fallen to predetermined limit values. After it has been established that the fluidized bed cooler has become substantially exhausted, the discharge conduit is closed. The supply conduit is opened to load a new material charge into the fluidized bed cooler. After the material charge has been loaded, the supply conduit is closed. Via a temperature measurement, the cooling of the material charge to the predetermined limit value of temperature is detected. The discharge conduit is then opened to discharge the charge from the fluidized bed cooler.

In an embodiment of the method, after the material charge has been cooled, samples are repeatedly taken from the cooled material, and the sample is analyzed to determine the current state of the bed in the fluidized bed furnace.

In an embodiment of the method, the fluidized bed furnace is used as a calcining kiln for the calcination of an ore concentrate. The material to be removed from the grate and cooled consists of coarse-grained, substantially non-fluidizable calcine material accumulated on the grate.

In an embodiment of the method, the material charge is cooled from a temperature of about 900° C.-1000° C. to a temperature of about 100° C.-400° C.

In an embodiment of the method, the material to be cooled consists of calcine of zinc ore concentrate.

In an embodiment of the apparatus, the supply valve is a flap valve.

In an embodiment of the apparatus, the discharge valve is a flap valve.

In an embodiment of the apparatus, the quantity detection means comprise a surface level detector for determining the material surface level in the fluidized bed space.

In an embodiment of the apparatus, the surface level detector is a surface level detector working on a radiometric level measurement principle and comprising a radiation source and a detector, which are mounted on the outside of the housing.

In an embodiment of the apparatus, the quantity detection means comprise a pressure detector, which is mounted in the air supply duct for measuring the counter-pressure of the fluidization air.

In an embodiment of the apparatus, the apparatus comprises a cleaning device for the cleaning of the supply conduit.

In an embodiment of the apparatus, the control device comprises means arranged to determine the filling time required for the loading of the fluidized bed cooler with a material charge of a predetermined size and to compare the measured filling time to a predetermined limit value of filling time, and if the measured filling time exceeds the predetermined limit value of filling time, the control device has been arranged to instruct the cleaning device to clean the supply conduit.

In an embodiment of the apparatus, the cleaning device is a pneumatic cleaning device, which has been arranged to blow pressurized air into the supply conduit.

In an embodiment of the apparatus, the cleaning device comprises a frame; a cleaning tube movably supported on the frame; a third power means for moving the cleaning tube, said third power means being controllable by the control device; and means for supplying pressurized air into the cleaning tube. The cleaning tube can be moved by the third power means between a cleaning position and a rest position, in which cleaning position the end of the cleaning tube is inside the second end of the supply conduit for blowing pressurized air into the supply conduit, and in which rest position the end of the cleaning tube is at a distance from the second end of the supply conduit.

In an embodiment of the apparatus, the apparatus comprises a sampling device connected to the discharge conduit for taking samples from the cooled material.

In an embodiment of the apparatus, the fluidized bed furnace is a calcining kiln for the calcination of an ore concentrate, such as zinc ore concentrate, and the material to be cooled consists of coarse-grained, substantially non-fluidizable calcine material to be removed from the grate of the calcining kiln.

In an embodiment of the apparatus, the fluidized bed cooler has been fitted to cool the material from 900° C.-1000° C. to a temperature of about 100° C.-400° C.

### LIST OF FIGURES

In the following, the invention will be described in detail with reference to embodiment examples and the attached drawing, which is a diagrammatic representation of an embodiment of the apparatus of the invention.

### DETAILED DESCRIPTION OF THE INVENTION

The below-described example embodiment of the invention relates to calcination of zinc concentrate in connection with hydrometallurgic zinc production. The purpose of the calcination of the concentrate is to convert sulfidic zinc into a soluble form before a solution treatment. This is accomplished in a fluidized bed furnace where, after ignition, the concentrate bed is oxidized at a temperature of about 900° C.-1000° C.

Although the invention is described here in connection with zinc production, it is applicable for any other purpose where fluidized bed furnaces are used and a hot particulate solid material is to be cooled to a lower temperature before being passed on for further treatment. Thus, the fluidized bed furnace may be e.g. a fluidized bed furnace intended for power plant use or the like.

From the calcining kiln, the calcine produced is removed at a rate of 5-8 t/h, most of which comes out by overflow of the calcining kiln while some of it drifts out with gas and is recovered in a boiler, cyclones and electric filters. In some calcining kilns, some of the calcine is extracted from the kiln by so-called underflow. By underflow of the kiln, even coarser non-fluidizable agglomerates formed in the kiln can be extracted. This coarse material consists of pellets of relatively regular particle size. Its particle size is such that the material will not rise at the speed of the fluidization gas, at 0.5-0.7 m/s, to overflow, but remains lying on the grate and gradually forms excrescences. The formation of coarse material depends on the impurity components of the feed mixture (Pb, Cu etc. contained in the concentrate). It is expressly important that, at the outlet of the calcining kiln, these pellets be extracted in a controlled manner because this affects the quantity in the bed in the kiln, and in metallurgic processes the delay also has an effect on the occurrence and degrees of reaction of the desired reactions. Depending on the concentrate, the oxidization of e.g. an 8-mm pellet takes from 30 minutes to two hours, so it is expressly important that the outlet flow be accurately controlled.

Unless the coarse calcine is discharged from the kiln, it may gradually accumulate on the grate in amounts large enough to cause problems, such as e.g. poor fluidization of the bed and/or formation of sinter on the bottom of the kiln and an increase of the counter-pressure produced by the bed. When impure concentrates are used, molten phases easily appear and, as a consequence of these, agglomerates are formed on the grate. The apparatus presented in the figure has been arranged to remove coarse material as referred to above from the grate 2 of a fluidized bed furnace 1 and to cool it from a temperature of about 900° C.-1000° C. to a temperature of about 100° C.-400° C.

The apparatus comprises a supply conduit 3 having an upper first end 4 and a lower second end 5. The first end 4 of the supply conduit 3 opens onto the horizontal grate 2 of the fluidized bed furnace 1 so that the material to be cooled can enter from the grate 2 into the supply conduit 3. The apparatus comprises a fluidized bed cooler 6. The fluidized bed cooler comprises a housing 7, and the second end 5 of the supply conduit 3 opens into the upper part of the housing. The housing 7 encloses an interior space. Attached to the wall of the housing 7 are cooling liquid tubes 8, in which a cooling liquid, such as water, is circulated to cool the material to be received into the interior space. Provided in the lower part inside the housing 7 is a second grate 9, which is provided with a number of through holes 10. The second grate 9 divides the interior space of the housing into a fluidized bed space 11 above the second grate 9, where the material to be cooled is present as a fluidized bed or mattress, and an air distribution space 12 below. An air supply duct 13 opens into the air distribution space 12 to supply air into the air distribution space 12. From the air distribution space 12, the air flows through the holes 10 of the second grate 9 into the fluidized bed space 11, fluidizing the material to be cooled that is present there and at the same time cooling it. A discharge conduit 14 opens into the lower part of the fluidized bed space 11 above the second grate 9 to remove the cooled material from the fluidized bed space.

The second end 5, i.e. the lower end of the supply conduit 3 is provided with a supply valve 5, which is a flap valve. When the flap of the supply valve 5 is in the open position, it permits the supply of material from the supply conduit 3 into the fluidized bed space 11. Similarly, when the flap of the supply valve 5 is in the closed position, it prevents the supply of material from the supply conduit 3 into the fluidized bed space 11. A first power means 16 has been arranged to open and close the flap of the supply valve 15.

The discharge conduit 14 is provided with a discharge valve 17, which is a flap valve. When the flap of the discharge valve 17 is in the open position, it permits the passage of material out of the fluidized bed space 11 into the discharge conduit 14. Similarly, when the flap of the discharge valve 17 is in the closed position, it prevents the passage of material out of the fluidized bed space 11. A second power means 18 has been arranged to open and close the flap of the discharge valve 17.

To generate quantity data regarding the quantity of material in the fluidized bed space 11, quantity detection means 19, 20 are provided. The quantity detection means comprise a surface level detector 19, which determines the surface level of the material in the fluidized bed space 11. The surface level detector 19 is preferably a surface level detector working on a radiometric level measurement principle and comprising a radiation source and a detector, which are mounted on the outside of the housing 7. In radiometric level measurement, the level of the surface is determined on the basis of the attenuation of gamma radiation occurring in a medium. The measuring equipment consists of a gamma radiator and a detector, which may be either an ionization chamber or a scintillation counter. Both the radiation source and the detector are mounted on the outside of the housing 7, and thus the effect of the medium, temperature and vibration on the measurement is eliminated. Furthermore, the quantity detection means comprise a pressure detector 20, which is mounted in the air supply duct 13 to measure the counter-pressure of fluidization air.

The apparatus further comprises temperature measuring means 21 for generating temperature data regarding the temperature of the material in the fluidized bed space.

A control device 22 has been arranged to control the first power means 16 to open and close the supply valve 15 and the second power means 18 to open and close the discharge valve 17 on the basis of the material quantity data and temperature data and the predetermined limit values of quantity and temperature so that the loading of material into the fluidized bed space of the fluidized bed cooler, its cooling and removal from the fluidized bed space take place in a charge-by-charge and cyclic manner as described above.

The apparatus further comprises a cleaning device 23 for cleaning the supply conduit 3.

The cleaning device 23 is a pneumatic cleaning device, which has been arranged to blow pressurized air into the supply conduit 3. The cleaning device 23 comprises a frame 24. A cleaning tube 25, through which pressurized air can be blown, is supported on the frame 24 so as to be movable back and forth substantially in the same direction in which the supply conduit 3 extends. The cleaning tube 25 is moved by a third power means 26. The third power means can also be controlled by the control device 22.

The cleaning tube 25 can be moved between a cleaning position and a rest position by the third power means 26. In the cleaning position, the flap of the supply valve 15 is in the open position to allow the end 27 of the cleaning tube 25 to be inserted into the second end 5 of the supply conduit 3 so that pressurized air can be blown from the cleaning tube 25 into the supply conduit 4 to blow any material obstructing it back into the fluidized bed furnace 1. In the rest position, the end 27 of the cleaning tube 25 is withdrawn to a distance from the second end 5 of the supply conduit 3.

The apparatus further comprises a sampling device 28 connected to the discharge conduit 14. The sampling device 28 makes it possible to take samples from the cooled material. The samples are analyzed to determine the current state of the bed in the fluidized bed furnace. The quality of the bed and the state of the furnace can be monitored by determining the particle size distribution of the sample and performing a chemical analysis on it.

The apparatus works automatically under control of the control device 22 as follows.

To load a first material charge into the fluidized bed cooler, the control device 22 gives a command to the first power means 16 to open the supply valve 15 so that the hot coarse-grained material can gravitate through the supply conduit 3 into the fluidized bed space 11 of the fluidized bed cooler 6. The discharge valve 17 in the discharge conduit 14 is in the closed position.

The surface level of the material accumulating in the fluidized bed cooler is measured continuously by the surface level detector 19 during the loading phase. When the material surface level has reached a predetermined limit value, which corresponds to the quantity of material in a charge to be loaded at one time, the control device 22 gives a command to the first power means 16 to close the supply valve 15. Instead of or along with the surface level measurement, the counter-pressure produced by the material in the fluidized bed space and acting against the supply of fluidization air can be measured by means of the pressure detector, and the supply valve 15 can be closed when the counter-pressure exceeds a predetermined limit value, which corresponds to the counter-pressure produced by the predetermined quantity of charge to be loaded at one time, indicating that a full charge has been reached.

In the fluidized bed cooler 6, the material charge is cooled by the fluidization air and the cooling liquid circulation 8 in the housing 7. The cooling is mainly effected via heat transfer into the cooling liquid. During the cooling, the temperature of the material charge is measured by a temperature detector 21, which transmits the temperature data to the control device 22. The control device 22 senses the cooling of the material charge to the predetermined limit value, which can be selected e.g. from the range of 100° C.-400° C. The control device 22 issues a command to the second power means 18 to open the discharge valve 17 so that the cooled material charge can be discharged into the discharge conduit 14. At the same time, the surface level detector 19 measures the surface level of the material in the fluidized bed space 11 and/or the pressure detector 20 measures the counter-pressure to determine whether the fluidized bed space 11 has been emptied. When the measured surface level and/or counter-pressure falls below the predetermined limit value, which means that the material charge has been substantially discharged into the discharge conduit 14, the control device 22 issues a second command to the second power means 18 to close the discharge valve 17 and a command to the first power means 16 to open the supply valve 15 so that the next material charge can be passed into the fluidized bed cooler 6. These steps are repeated.

The supply conduit 3 is cleaned periodically by the cleaning device 23 at regular or irregular time intervals. The control device 22 is provided with a clock, which measures the filling time required for loading the fluidized bed cooler 6 with a material charge of predetermined size. The control device 22 compares the measured filling time to a predetermined limit value of filling time. If the measured filling time exceeds the predetermined limit value, which means that the supply conduit is partly or completely blocked, then the control device 22 will instruct the cleaning device 23 to clean the supply conduit 3.

The invention is not limited to the embodiment examples described above; instead, many variations are possible within the scope of the inventive concept defined in the claims.

1. A method for cooling a material to be removed from the grate of a fluidized bed furnace, in which method the material at a high temperature is passed from the grate of the fluidized bed furnace into a separate fluidized bed cooler, the material is cooled in the fluidized bed cooler partly by fluidization air and partly by heat transfer into a cooling liquid circulation system, and the cooled material is discharged from the fluidized bed cooler, and in which method
a) a charge of material containing material to be cooled is loaded into the fluidized bed cooler,
b) during cooling, the temperature of the charge is measured,
c) the cooled charge is discharged from the fluidized bed cooler when the temperature of the charge as indicated by the temperature measurement has fallen to a predetermined limit value of temperature, and
d) steps a)-c) are repeated cyclically, wherein, during the loading step a), the quantity of the material accumulating in the fluidized bed cooler is measured, and the supply of material into the fluidized bed cooler is prevented when the quantity of the material in the fluidized bed cooler corresponds to a predetermined quantity of a charge to be loaded at one time.

2. A method according to claim 1, wherein during the loading step a), the surface level of the material accumulating in the fluidized bed cooler is measured, and when the measured surface level has reached a predetermined limit value, which corresponds to a predetermined quantity of a charge to be loaded at one time, the supply of material into the fluidized bed cooler is prevented.

3. A method according to claim 1 wherein during the loading step a), the fluidization air counter-pressure caused by the material is measured, and when the measured counter-pressure has reached a predetermined limit value, which corresponds to a predetermined quantity of a charge to be loaded at one time, the supply of material into the fluidized bed cooler is prevented.

4. A method according to claim 1, wherein a supply conduit extending between the grate of the fluidized bed furnace and the fluidized bed cooler is provided, and during the loading step a) the material is allowed to flow out from the grate via the supply conduit into the fluidized bed cooler by gravitation.

5. A method according to claim 1, wherein the fluidized bed cooler is provided with a discharge conduit for discharge of material from the fluidized bed cooler, and during the discharge step c) the material is allowed to flow out of the fluidized bed cooler via the discharge conduit by gravitation.

6. A method according to claim 1, wherein the supply conduit is cleaned periodically at regular or irregular time intervals.

7. A method according to claim 1, wherein the filling time required for filling the fluidized bed cooler with a material charge is determined, the measured filling time is compared to a predetermined filling time limit value, and if the measured filling time exceeds the predetermined limit value, then the supply conduit is cleaned.

8. A method according to claim 6, wherein the supply conduit is cleaned by blowing pressurized air through the supply conduit.

9. A method according to claim 1, wherein
the exhaustion of the fluidized bed cooler is established on the basis of a determination of surface level and/or counter-pressure after the surface level and/or counter-pressure have/has fallen to predetermined limit values,
after it has been established that the fluidized bed cooler has become substantially exhausted, the discharge conduit is closed,
the supply conduit is opened to load a material charge to be cooled into the fluidized bed cooler,
the supply conduit is closed after the material charge has been loaded,
the cooling of the material charge to the predetermined limit value of temperature is detected via a temperature measurement, and
the discharge conduit is opened to remove the charge.

10. A method according to claim 1, wherein, after the material charge has been cooled, samples are repeatedly taken from the cooled material, and the sample is analyzed to determine the current state of the bed in the fluidized bed furnace.

11. A method according to claim 1, wherein the fluidized bed furnace is used as a calcining kiln for the calcination of an ore concentrate, and the material to be removed from the grate and cooled consists of coarse-grained, substantially non-fluidizable calcine material accumulated on the grate.

12. A method according to claim 11, wherein the material charge is cooled from a temperature of about 900° C.-1000° C. to a temperature of about 100° C.-400° C.

13. A method according to claim 11 wherein the material to be cooled consists of calcine of zinc ore concentrate.

14. An apparatus for cooling a material to be removed from a first grate of a fluidized bed furnace, said apparatus comprising
a supply conduit having an upper first end, which opens onto the first grate to receive the material to be cooled from the grate into the supply conduit, and a lower second end,
a fluidized bed cooler, which comprises
a housing, into the upper part of which the second end of the supply conduit opens, which housing encloses an interior space for receiving the material and to which housing are connected cooling liquid tubes for cooling the material in the interior space,
a second grate 9, which is provided with a number of through holes and which second grate has been arranged to divide the interior space of the housing into a fluidized bed space above the second grate, where the material to be cooled is present as a fluidized bed, and an air distribution space below the second grate,
an air supply duct, which opens into the air distribution space to supply air into the air distribution space and from there further through the holes of the second grate into the fluidized bed space for fluidizing and cooling the material to be cooled, and
discharge conduit, which opens into the fluidized bed space to remove cooled material from the fluidized bed space,
a discharge valve provided in the discharge conduit, which discharge valve in an open position allows and in a closed position prevents the passage of material out of the fluidized bed space,
a second power means for opening and closing the discharge valve, and
temperature measuring means for producing temperature data regarding the temperature of the material in the fluidized bed space, wherein the apparatus comprises
a supply valve disposed at the second end of the supply conduit, which supply valve in an open position allows and in a closed position prevents the supply of material into the fluidized bed space,
a first power means for opening and closing the supply valve,
quantity detection means for producing quantity data regarding the quantity of material in the fluidized bed space, and
a control device, which has been arranged to control the first power means for opening and closing the supply valve and the second power means for opening and closing the discharge valve on the basis of the quantity data and temperature data and predetermined limit values of quantity and temperature, so that the loading of material into the fluidized bed space of the fluidized bed cooler and its cooling and removal from the fluidized bed space take place in a charge-by-charge and cyclic manner.

15. An apparatus according to claim 14, wherein the supply valve is a flap valve.

16. An apparatus according to claim 14, wherein the discharge valve is a flap valve.

17. An apparatus according to claim 14, wherein the quantity detection means comprise a surface level detector for determining the material surface level in the fluidized bed space.

18. An apparatus according to claim 15, wherein the surface level detector is a surface level detector working on a radiometric level measurement principle and comprising a radiation source and a detector, which are mounted on the outside of the housing.

19. An apparatus according to claim 14, wherein the quantity detection means comprise a pressure detector, which is mounted in the air supply duct for measuring the counter-pressure of the fluidization air.

20. An apparatus according to claim 14, wherein the apparatus comprises a cleaning device for the cleaning of the supply conduit.

21. An apparatus according to claim 20, wherein the control device comprises means arranged to determine the filling time required for the loading of the fluidized bed cooler with a material charge of a predetermined size and to compare the measured filling time to a predetermined limit value of filling time, and if the measured filling time exceeds the predetermined limit value of filling time, the control device has been arranged to instruct the cleaning device to clean the supply conduit.

22. An apparatus according to claim 20, wherein the cleaning device is a pneumatic cleaning device, which has been arranged to blow pressurized air into the supply conduit.

23. An apparatus according to claim 22, wherein the cleaning device comprises a frame; a cleaning tube movably supported on the frame, a third power means for moving the cleaning tube, said third power means being controllable by the control device; and means for supplying pressurized air into the cleaning tube, the cleaning tube being movable by the third power means between a cleaning position and a rest position, and in which cleaning position the end of the cleaning tube is inside the second end of the supply conduit for blowing pressurized air into the supply conduit, and in which rest position the end of the cleaning tube is at a distance from the second end of the supply conduit.

24. An apparatus according to claim 14, wherein the apparatus comprises a sampling device connected to the discharge conduit for taking samples from the cooled material.

25. An apparatus according to claim 14, wherein the fluidized bed furnace is a calcining kiln for the calcination of an ore concentrate, such as zinc ore concentrate, and the material to be cooled consists of coarse-grained, substantially non-fluidizable calcine material to be removed from the grate of the calcining kiln.

26. (canceled)
